(19) United States
(12) Patent Application Publication
(10) Pub. No.: US 2026/0001567 A1
(43) Pub. Date: Jan. 1, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Toru Kokaki, Tokyo (JP); Daichi Kato, Tokyo (JP)

(21) Appl. No.: 19/246,792

(22) Filed: Jun. 24, 2025

(30) Foreign Application Priority Data
Jun. 28, 2024 (JP) 2024-104753

(51) Int. Cl. B60W 50/10; B60W 10/20; B60W 30/18; B60W 50/14

(52) U.S. Cl. CPC B60W 50/10; B60W 10/20; B60W 30/18163; B60W 50/14; B60W 2710/20; B60W 2720/10

(57) ABSTRACT

According to an embodiment, a vehicle control device includes a recognizer configured to recognize a surrounding situation of a vehicle, a driving controller configured to execute driving control for controlling at least one of steering and a speed of the vehicle on the basis of the surrounding situation, and an operator configured to receive an operation from an occupant of the vehicle. The driving controller executes the driving control on the basis of any one of a plurality of control aspects including first control and second control. The driving controller executes switching from the first control to the second control or switching from the second control to the first control when an instruction is received from the operator if the control aspect is switchable on the basis of the surrounding situation. The driving controller prevents the switching from being executed when the instruction is not received from the operator.

### CROSS-REFERENCE TO RELATED APPLICATION

Priority is claimed on Japanese Patent Application No. 2024-104753, filed June 28, 2024, the content of which is incorporated herein by reference.

### BACKGROUND

### FIELD OF THE INVENTION

The present invention relates to a vehicle control device, a vehicle control method, and a storage medium.

### DESCRIPTION OF RELATED ART

In recent years, efforts to provide access to sustainable transportation systems have been increasingly active in consideration of vulnerable individuals among participants in transportation. In pursuit of this realization, research and development (R&D) in driving assistance technology is being emphasized to further improve the safety and convenience of transportation. In this regard, technology in which a receiver receives an operation for selecting one or more driving modes from a plurality of driving modes having different control characteristics regarding acceleration/deceleration or turning of a vehicle from an occupant, and the vehicle is automatically driven on the basis of the driving mode of the selection operation received by the receiver is known (e.g., Japanese Unexamined Patent Application, First Publication No. 2017-206152).

### SUMMARY

Meanwhile, it is desirable to prompt an occupant to switch a control aspect according to a surrounding situation of a vehicle and to prevent an operation from becoming complicated when the occupant’s operation differs according to the control aspect in driving assistance technology. In this regard, there is still room for further study.

The present application has been made in consideration of such circumstances and an objective of the present application is to provide a vehicle control device, a vehicle control method, and a storage medium that can provide more appropriate driving control in accordance with a surrounding situation of a vehicle. Also, the present invention contributes to the development of a sustainable transportation system.

A vehicle control device, a vehicle control method, and a storage medium according to the present invention adopt the following configurations.

1: According to an aspect of the present invention, there is provided a vehicle control device including: a recognizer configured to recognize a surrounding situation of a vehicle; a driving controller configured to execute driving control for controlling at least one of steering and a speed of the vehicle on the basis of the surrounding situation; and an operator configured to receive an operation from an occupant of the vehicle, wherein the driving controller executes the driving control on the basis of any one of a plurality of control aspects including first control and second control having content of driving assistance different from that of the first control, wherein the driving controller executes switching from the first control to the second control or switching from the second control to the first control when an instruction is received from the operator if the control aspect is switchable on the basis of the surrounding situation, and wherein the driving controller prevents the switching from being executed when the instruction is not received from the operator.

2: In the above-described aspect (1), the driving controller decides whether or not to execute a predetermined operation on the basis of content received by the operator during execution of the second control, and the driving controller executes the predetermined operation regardless of the presence or absence of an operation of the operator during execution of the first control.

3: In the above-described aspect (2), the predetermined operation includes a lane change of the vehicle.

4: In the above-described aspect (1), the driving controller switches the control to third control different from the first control and the second control when a state of the vehicle satisfies a predetermined condition during execution of the first control or the second control, and an instruction to switch the control to the third control is issued according to an operation different from an operation for switching from the first control to the second control and an operation for switching from the second control to the first control.

5: In the above-described aspect (4), the driving controller switches the control to control different from the first control or the second control when an execution condition for the third control is not satisfied during execution of the third control.

6: In the above-described aspect (1), the driving controller includes a first control device configured to execute the first control; and a second control device configured to execute the second control, and the driving controller generates a target trajectory of the vehicle with the first control device in the first control, and generates a target trajectory of the vehicle with the second control device in the second control.

7: In the above-described aspect (1), the operator includes a plurality of operation elements including a first operation element, a second operation element, and a third operation element, the first operation element receives an instruction to execute the first control or the second control or an instruction to switch the control to the first control or the second control and an instruction to start or end execution of a predetermined operation when the second control is executed, the second operation element receives a setting speed of the vehicle in the predetermined operation and receives a lane change instruction, and the third operation element performs an operation for information displayed on a display when the second control is executed and receives an instruction regarding a lane change when the first control is executed.

8: In the above-described aspect (1), the vehicle control device further includes a notifier configured to provide notifications of current and future vehicle states when an execution condition for the control aspect is satisfied.

9: In the above-described aspect (8), the driving controller prevents the control from being switched to the first control when a state in which the operator is not operated continues for a predetermined time or more after an inquiry regarding the switching to the first control is provided to the notifier during execution of the second control.

10: In the above-described aspect (1), the driving controller classifies an area where the first control is executable and an area where the second control is executable on the basis of a road situation of the vehicle.

11: According to an aspect of the present invention, there is provided a vehicle control method including: recognizing, by a computer, a surrounding situation of a vehicle; executing, by the computer, driving control for controlling at least one of steering and a speed of the vehicle on the basis of the surrounding situation; executing, by the computer, the driving control on the basis of any one of a plurality of control aspects including first control and second control having content of driving assistance different from that of the first control; executing, by the computer, switching from the first control to the second control or switching from the second control to the first control when an instruction is received from an operator configured to receive an operation from an occupant of the vehicle if the control aspect is switchable on the basis of the surrounding situation; and preventing, by the computer, the switching from being executed when the instruction is not received from the operator.

12: According to an aspect of the present invention, there is provided a computer-readable non-transitory storage medium storing a program for causing a computer to: recognize a surrounding situation of a vehicle; execute driving control for controlling at least one of steering and a speed of the vehicle on the basis of the surrounding situation; execute the driving control on the basis of any one of a plurality of control aspects including first control and second control having content of driving assistance different from that of the first control; execute switching from the first control to the second control or switching from the second control to the first control when an instruction is received from an operator configured to receive an operation from an occupant of the vehicle if the control aspect is switchable on the basis of the surrounding situation; and prevent the switching from being executed when the instruction is not received from the operator.

According to the above-described aspects (1) to (12), it is possible to execute more appropriate driving control in accordance with a surrounding situation of a vehicle.

### BRIEF DESCRIPTION OF THE DRAWINGS

FIG. 1 is a configuration diagram of a vehicle system using a vehicle control device according to an embodiment.

FIG. 2 is a functional configuration diagram of a first controller.

FIG. 3 is an explanatory diagram of a travel scene in which first control and second control are executable.

FIG. 4 is an explanatory diagram of specific examples of application ranges of the first control and the second control.

FIG. 5 is an explanatory diagram of further specific examples of an application range of the first control.

FIG. 6 is a diagram showing an example of an operator.

FIG. 7 is a flowchart showing an example of a flow of a process executed by the vehicle system according to the embodiment.

### DESCRIPTION OF EMBODIMENTS

Hereinafter, embodiments of a vehicle control device, a vehicle control method, and a storage medium of the present invention will be described with reference to the drawings.

### Overall Configuration

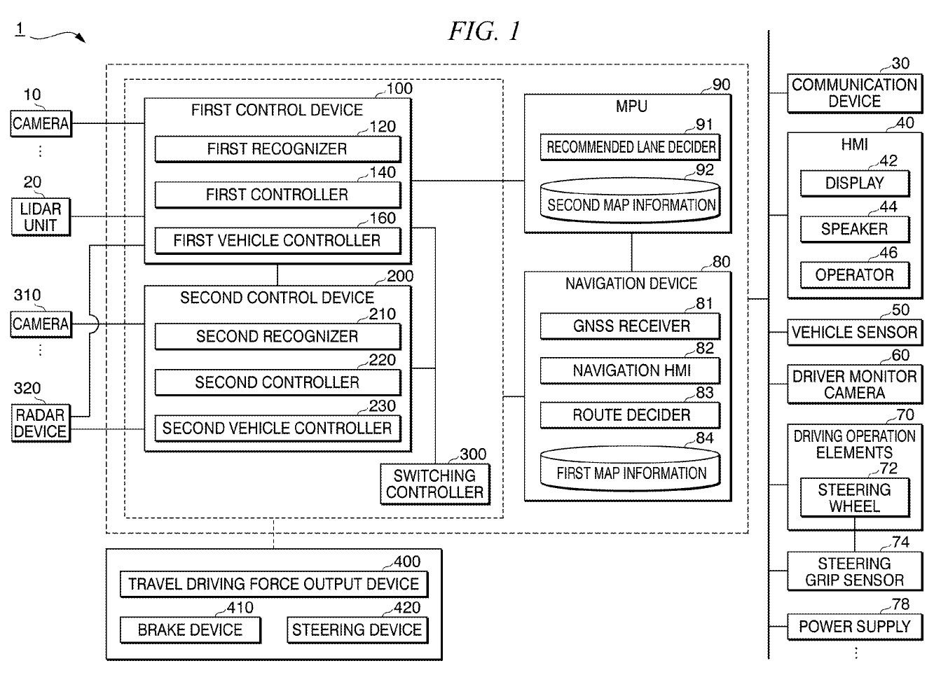

FIG. 1 is a configuration diagram of a vehicle system 1 using the vehicle control device according to the embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery or a fuel cell is discharged. In the following description, the vehicle will be described as a hybrid vehicle using an internal combustion engine and an electric motor for a four-wheeled vehicle as drive sources.

The vehicle system 1 includes, for example, a camera 10, a light detection and ranging (LIDAR) unit 20, a communication device 30, a human-machine interface (HMI) 40, a vehicle sensor 50, a driver monitor camera 60, driving operation elements 70, a steering grip sensor 74, a power supply 78, a navigation device 80, a map positioning unit (MPU) 90, and a first control device 100.

Furthermore, the vehicle system 1 includes, for example, a second control device 200, a camera 310, a radar device 320, a travel driving force output device 400, a brake device 410, and a steering device 420. Furthermore, the vehicle system 1 includes, for example, a switching controller 300. The HMI 40 is an example of a “notifier.” The first control device 100, the second control device 200, the switching controller 300, the HMI 40, the driving operation elements 70, and the navigation device 80 are examples of a “driving control device.” A first recognizer 120 and a second recognizer 210 are examples of a “recognizer.” The first controller 140, the first vehicle controller 160, the second controller 220, the second vehicle controller 230, and the switching controller 300 are examples of a “driving controller.” The driving controller in the embodiment executes driving control on the basis of any one of a plurality of control aspects including first control and second control in which content of driving assistance is different from that of the first control to be described below.

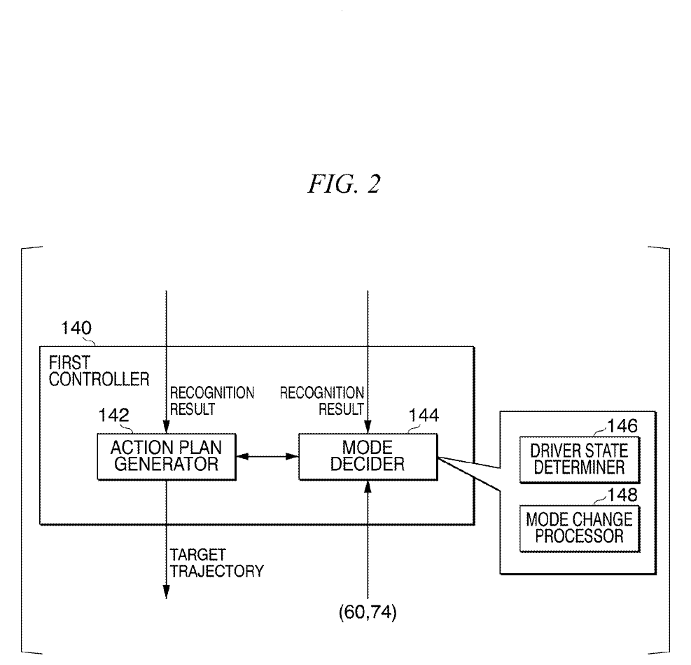

Such devices and equipment are connected to each other by a multiplex communication line such as a controller area network (CAN) communication line, a serial communication line, a wireless communication network, or the like. The configuration shown in FIG. 1 and a configuration shown in FIG. 2 to be described below are merely examples and some of the constituent elements may be omitted or other constituent elements may be further added. Furthermore, functional constituent elements are integrated or distributed.

For example, the camera 10 is a digital camera using a solid-state imaging element such as a charge-coupled device (CCD) or a complementary metal oxide semiconductor (CMOS). The camera 10 is attached to any location on a vehicle (hereinafter referred to as a vehicle M) in which the vehicle system 1 is mounted. For example, when the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The LIDAR unit 20 radiates light (or electromagnetic waves with a wavelength close to that of light) around the vehicle M and measures scattered light. The LIDAR unit 20 detects a distance to a target on the basis of a period of time from light emission to light reception. The radiated light is, for example, pulsed laser light. The LIDAR unit 20 may be attached to any location. However, a sensor part of the LIDAR unit 20 is attached to a position where information about surroundings including the front of the vehicle M can be acquired, such as its roof. An electronic control unit (ECU) may be provided in the LIDAR unit 20.

The communication device 30 communicates with another vehicle located in the vicinity of the vehicle M using, for example, a cellular network, a Wi-Fi network, Bluetooth (registered trademark), dedicated short-range communication (DSRC), or the like, or communicates with various types of server devices via a radio base station.

The HMI 40 presents various types of information to an occupant of the vehicle M and receives an input operation from the occupant. The HMI 40 includes, for example, a display 42, a speaker 44, and an operator 46. The display 42 is, for example, a liquid crystal display (LCD) or an organic electro-luminescence (EL) display device or the like. The display 42, for example, is provided in an instrument panel and an instrument display. The display 42 displays various types of images (including a video) in the embodiment. The display 42 may be integrated with an inputter as a touch panel. The speaker 44 outputs a predetermined sound (e.g., an alert or the like) to a vehicle cabin. The operator 46, for example, receives an operation from the occupant for switching between the start and end of a control aspect of the vehicle M to be described below, switching to another control aspect, or the like. The operator 46 may receive an operation for setting a parameter (e.g., speed adjustment) in control being executed, an operation for switching between modes, and the like. The operator 46, for example, may be provided on the steering wheel 72 or the like, or on a touch panel of the display 42. The HMI 40 may have a microphone, a buzzer, a vibration generator (vibrator), keys, and the like in addition to the display 42, the speaker 44, and the operator 46. The HMI 40 may include an outputter that prompts the driver to grip the steering wheel, and a head-up display (HUD).

The vehicle sensor 50 includes various sensors for use in controlling the vehicle such as a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like. The vehicle sensor 50 may include a position sensor configured to detect a position of the vehicle M. The position sensor is, for example, a sensor configured to acquire position information (longitude/latitude information) from a Global Positioning System (GPS) device. The position sensor may be a sensor configured to acquire position information using a global navigation satellite system (GNSS) receiver 81 of the navigation device 80.

The driver monitor camera 60 is, for example, a digital camera that uses a solid-state image sensor such as a CCD or a CMOS. The driver monitor camera 60 is attached to any location on the vehicle M with respect to a position and a direction where the head of the driver sitting in the driver’s seat of the vehicle M can be imaged from the front (in a direction in which his/her face is imaged). For example, the driver monitor camera 60 is attached to an upper part of a display device provided on the central portion of the instrument panel of the vehicle M.

For example, the driving operation elements 70 include an accelerator pedal, a brake pedal, a shift lever, and other operation elements in addition to a steering wheel 72. A sensor configured to detect an amount of operation or the presence or absence of an operation is attached to the driving operation element 70 and a detection result of the sensor is output to the first control device 100, the second control device 200, the switching controller 300, or some or all of the travel driving force output device 400, the brake device 410, and the steering device 420. The steering wheel 72, for example, may be annular or may be in the form of a variant steering wheel, a joystick, a button, or the like. The steering grip sensor 74 is attached to the steering wheel 72. The steering grip sensor 74 is implemented by a capacitance sensor or the like and outputs a signal for detecting whether or not the driver is gripping the steering wheel 72 (indicating that the driver is in contact with the steering wheel 72 in a state in which a force can be applied) to the first control device 100, the second control device 200, or the switching controller 300. The operator 46, which switches a control aspect for the vehicle M, sets parameters, and the like, may be provided on the steering wheel 72.

The power supply 78 is a battery that supplies electric power to the vehicle system 1. The power supply 78 may include a plurality of batteries and may be configured to be redundant so that electric power is supplied from the other battery when a failure occurs in one battery.

For example, the navigation device 80 includes the GNSS receiver 81, a navigation HMI 82, and a route decider 83. The navigation device 80 holds first map information 84 in a storage device such as a hard disk drive (HDD) or a flash memory. The GNSS receiver 81 identifies a position of the vehicle M on the basis of a signal received from a GNSS satellite. The position of the vehicle M may be identified or supplemented by an inertial navigation system (INS) using an output of the vehicle sensor 50. The navigation HMI 82 includes a display device, a speaker, a touch panel, keys, and the like. The navigation HMI 82 may be partly or wholly shared with the above-described HMI 40. For example, the route decider 83 decides a route (hereinafter referred to as a route on a map) from the position of the vehicle M identified by the GNSS receiver 81 (or any input position) to a destination input by the occupant using the navigation HMI 82 with reference to the first map information 84. The first map information 84 is, for example, information in which a road shape is expressed by a link indicating a road and nodes connected by the link. The first map information 84 may include point of interest (POI) information, and the like. The route on the map is output to the MPU 90. The navigation device 80 may provide route guidance using the navigation HMI 82 on the basis of the route on the map. The navigation device 80 may be implemented, for example, according to a function of a terminal device such as a smartphone or a tablet terminal possessed by the occupant. The navigation device 80 may transmit a current position and a destination to a navigation server via the communication device 30 and acquire a route equivalent to the route on the map from the navigation server.

For example, the MPU 90 includes a recommended lane decider 91 and stores second map information 92 in a storage device such as an HDD or a flash memory. The recommended lane decider 91 divides the route on the map provided from the navigation device 80 into a plurality of blocks (e.g., divides the route every 100 [m] in a travel direction of the vehicle), and decides a recommended lane for each block with reference to the second map information 92. The recommended lane decider 91 decides in what lane numbered from the left the vehicle will travel. The recommended lane decider 91 decides the recommended lane so that the vehicle M can travel along a reasonable route for traveling to a branching destination when there is a branch point on the route on the map. The MPU 90 recognizes the position of the vehicle M on the basis of a detection result of a gyro sensor (not shown), the position of the vehicle M identified by the GNSS receiver 81, and the like.

The second map information 92 is map information having higher accuracy than the first map information 84. The second map information 92 includes, for example, information about a center of lanes or information about boundaries between lanes. The second map information 92 may include road information, traffic regulation information, address information (addresses and postal codes), facility information, telephone number information, and the like. The road information may include, for example, road type information such as expressways and general roads, road shape information such as junctions, branches, T-intersections, and curvatures (or curvature radii), other road information such as the number of lanes, road gradients, junctions (JCTs), service areas, toll booths, and zebra zones (guiding strips), and the like. The second map information 92 may be updated at any time by the communication device 30 communicating with other devices.

### First Control Device

The first control device 100 includes, for example, a first recognizer 120, a first controller 140, and a first vehicle controller 160. The first recognizer 120, the first controller 140, and the first vehicle controller 160 are implemented by, for example, a hardware processor such as a central processing unit (CPU) executing a program (software). Some or all of these constituent elements may be implemented by hardware (including circuitry) such as a large-scale integration (LSI) circuit, an application-specific integrated circuit (ASIC), a field-programmable gate array (FPGA), a graphics processing unit (GPU), or a system on chip (SOC), or may be implemented by software and hardware in cooperation. The program may be stored in advance in a device such as the HDD or flash memory of the first control device 100 (a storage device with a non-transitory storage medium). Alternatively, the program may be stored in a removable storage medium such as a DVD or CD-ROM and installed in the HDD or flash memory of the first control device 100 when the storage medium (the non-transitory storage medium) is mounted in a drive device.

The first recognizer 120 performs a sensor fusion process for detection results of one or both of the camera 10 and the LIDAR unit 20 to recognize the surrounding situation of the vehicle M. For example, the second recognizer 210 recognizes a position, type, speed, and the like of a physical object located near the vehicle M (within a predetermined distance) from a result of the sensor fusion process. This function may be included in the LIDAR unit 20, or may be provided as a configuration different from the LIDAR unit 20 and the first control device 100. The first recognizer 120 may perform the sensor fusion process further using the detection results of the camera 310 or the radar device 320 to be described below. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by a represented area. The “state” of the physical object may include the acceleration or jerk of the physical object, or the “action state” (e.g., whether or not the lane is changing or is about to change).

The first recognizer 120, for example, recognizes a lane in which the vehicle M is traveling (a travel lane). For example, the first recognizer 120 recognizes the travel lane by comparing a pattern of road markings (e.g., an arrangement of solid lines and broken lines) obtained from the second map information 92 with a pattern of road markings in the vicinity of the vehicle M recognized from an image captured by the camera 10. The first recognizer 120 may recognize the travel lane by recognizing a course boundary (a road boundary) including a road marking, a shoulder, a curb, a median strip, a guardrail, and the like as well as a road marking. In this recognition, a position of the vehicle M acquired from the navigation device 80 or a processing result of the INS may be taken into account. The first recognizer 120 recognizes a temporary stop line, an obstacle, red traffic light, a toll gate, and other road events.

When the travel lane is recognized, the first recognizer 120 recognizes a position or an orientation of the vehicle M with respect to the travel lane. For example, the first recognizer 120 may recognize the deviation of a reference point of the vehicle M from the center of the lane and an angle formed between the travel direction of the vehicle M and a line connected to the center of the lane as a relative position and orientation of the vehicle M related to the travel lane. Alternatively, the first recognizer 120 may recognize a position of the reference point of the vehicle M related to one side end portion (a road marking or a road boundary) of the travel lane or the like as a relative position of the vehicle M related to the travel lane.

For example, the first recognizer 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both recognitions. Thereby, the reliability of automated driving (driving control) is secured. The first recognizer 120 may be omitted and the processing result of the second recognizer 210 to be described below may be used.

The first controller 140 executes control to assist the occupant (the driver) in driving based on the recognition result of the first recognizer 120. FIG. 2 is a functional configuration diagram of the first controller 140. The first controller 140 includes, for example, an action plan generator 142 and a mode decider 144.

The action plan generator 142 generates a future target trajectory along which the vehicle M will automatically travel (independently of the driver’s operation) so that the vehicle M can generally travel in the recommended lane decided by the recommended lane decider 91 and further cope with a surrounding situation of the vehicle M. For example, the target trajectory includes a speed element. For example, the target trajectory is represented by sequentially arranging points (trajectory points) at which the vehicle M is required to arrive. The trajectory points are points at which the vehicle M is required to arrive for each predetermined traveling distance (e.g., about several meters [m]) along a road. In addition, a target speed and target acceleration for each predetermined sampling time (e.g., about 0.x [sec] where x is a decimal number) are generated as parts of the target trajectory. The trajectory point may be a position where the vehicle M is required to arrive at the sampling time for each predetermined sampling time. In this case, information of the target speed and the target acceleration is represented by an interval between the trajectory points.

The action plan generator 142 may set an automated driving event when a target trajectory is generated. Automated driving events include a constant-speed traveling event, a low-speed tracking traveling event, a lane change event, a branching event, a merging event, a takeover event, and the like. The action plan generator 142 generates a target trajectory according to an activated event.

The mode decider 144 decides the driving mode of the vehicle M as any of a plurality of driving modes in which the tasks imposed on the driver are different. The mode decider 144 includes, for example, a driver state determiner 146 and a mode change processor 148.

Here, the vehicle system 1 can execute a plurality of driving modes of the vehicle M. The plurality of driving modes are, for example, modes with different degrees of automation of the control state, i.e., the driving control of the vehicle M. A high degree of automation indicates that the vehicle system 1 has a high degree of control over the vehicle M, in other words, the degree to which the driver intervenes in the control (driving operation) of the vehicle M is low. In accordance with the degree of automation, tasks imposed on the driver differ. For example, when the degree of automation is higher, the task is lighter. Examples of the tasks include the driver’s forward monitoring, gripping of the steering wheel 72, an acceleration/deceleration operation, and the like. For example, in a driving mode with a high degree of automation, for example, automated driving is executed in a state in which forward monitoring of the driver, gripping of the steering wheel 72, and an acceleration/deceleration operation are not imposed on the driver. Automated driving indicates that both steering and acceleration/deceleration are controlled regardless of the driver’s operation. A forward area is an area visible through the front windshield in the travel direction of the vehicle M. For example, when the vehicle M is traveling at a predetermined speed (e.g., about 60 [km/h]) or less on a motorway such as an expressway and a condition in which a preceding vehicle to be tracked is present or the like is satisfied, a driving mode in which the above-described tasks are not imposed on the driver is executed. This driving mode is sometimes referred to as traffic jam pilot (TJP). When this condition is no longer satisfied, the mode decider 144 changes the driving mode to another driving mode.

When the driver does not execute a task related to a decided driving mode (hereinafter, a current driving mode), the mode decider 144 changes the driving mode of the vehicle M to a driving mode with a heavier task. For example, when the driver is in a posture in which the driving mode is not switched to manual driving in accordance with a request from the system in a driving mode with a high degree of automation (e.g., when the driver continues to look away from the vehicle outside the allowable area or when a sign of driving difficulty is detected), the mode decider 144 prompts the driver to switch the driving mode to the manual driving using the HMI 40 or a predetermined outputter that prompts the occupant to grip the steering wheel and performs a control process in which the vehicle M is gradually stopped by pulling over to the shoulder of the road and the automated driving is stopped if the driver does not respond. After the automated driving is stopped, the vehicle M switches the driving mode to a driving mode with a low degree of automation, and the vehicle M can be started according to the driver’s manual operation. Hereinafter, the same is true for “stopping automated driving.”

The driver state determiner 146 monitors the driver’s state for the above-described mode change and determines whether or not the driver’s state is a state according to the task. For example, the driver state determiner 146 analyzes an image captured by the driver monitor camera 60 and performs a posture estimation process to determine whether or not the driver is in a posture that the driving mode can be switched to the manual driving in response to a request from the system. The driver state determiner 146 analyzes an image captured by the driver monitor camera 60 and performs a line-of-sight estimation process to determine whether or not the driver is performing forward monitoring.

The mode change processor 148 performs various types of processes for changing the mode. For example, the mode change processor 148 instructs the action plan generator 142 to generate a target trajectory for stopping on the shoulder of the road, instructs the second control device 200 to operate, and controls the HMI 40 so that the driver is prompted to take an action.

The first vehicle controller 160 controls the travel driving force output device 400, the brake device 410, and the steering device 420 so that the vehicle M passes through the target trajectory generated by the action plan generator 142 at the scheduled time. The second vehicle controller 230 may provide information about the target trajectory to the second control device 200 and control the travel driving force output device 400, the brake device 410, and the steering device 420 via the second control device 200. The first vehicle controller 160 executes junction passing control and merging control of the vehicle M as an example. The junction passing control is control for causing the vehicle M to travel while maintaining a lane in a junction or control for selecting a lane in which the vehicle M will travel in the junction. The merging control is control for causing the vehicle M to make a lane change to a merge lane when the vehicle M merges from the merge lane to a main lane.

The travel driving force output device 400 outputs a travel driving force (torque) for enabling the traveling of the vehicle M to driving wheels. For example, the travel driving force output device 400 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the first control device 100 or the second control device 200 or information input from the driving operation element 70.

For example, the brake device 410 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the first control device 100 or the second control device 200 or the information input from the driving operation element 70 so that brake torque according to a braking operation is output to each wheel. The brake device 410 may include a mechanism configured to transfer the hydraulic pressure generated according to an operation on the brake pedal to the cylinder via a master cylinder as a backup. Also, the brake device 410 is not limited to the above-described configuration and may be an electronically controlled hydraulic brake device configured to control an actuator in accordance with information input from the first control device 100 or the second control device 200 and transfer the hydraulic pressure of the master cylinder to the cylinder.

For example, the steering device 420 includes a steering ECU and an electric motor. For example, the electric motor changes a direction of steerable wheels by applying a force to a rack and pinion mechanism. The steering ECU drives the electric motor in accordance with the information input from the first control device 100 or the second control device 200 or the information input from the driving operation element 70 to change the direction of the steerable wheels.

For example, the camera 310 is a digital camera using a solid-state imaging element such as a CCD or a CMOS. The camera 310 is attached to any location on the vehicle M. For example, the camera 310 periodically and iteratively images the surroundings of the vehicle M. The camera 310 may be a stereo camera. The cameras 310 and 10 may be the same camera.

The radar device 320 radiates radio waves such as millimeter waves around the vehicle M and detects at least a position of a physical object (a distance from the physical object and a direction thereof) by detecting radio waves (reflected waves) reflected by the physical object. The radar device 320 is attached to any location on the vehicle M. The radar device 320 may detect a position and speed of the physical object in a frequency modulated continuous wave (FM-CW) scheme.

### Second Control Device

The second control device 200 includes, for example, a second recognizer 210, a second controller 220, and a second vehicle controller 230. The second recognizer 210, the second controller 220, and the second vehicle controller 230 are implemented, for example, by a hardware processor such as a CPU executing a program (software). Some or all of these constituent elements may be implemented by hardware (including circuitry) such as an LSI circuit, an ASIC, an FPGA, a GPU, or an SOC, or may be implemented by software and hardware in cooperation. The program may be stored in advance in a device such as the HDD or flash memory of the second control device 200 (a storage device with a non-transitory storage medium). Alternatively, the program may be stored in a removable storage medium such as a DVD or CD-ROM and installed in the HDD or flash memory of the second control device 200 when the storage medium (the non-transitory storage medium) is mounted in a drive device.

The second recognizer 210 performs a sensor fusion process for detection results of one or both of the camera 310 and the LIDAR device 320 to recognize the surrounding situation of the vehicle M. For example, the second recognizer 210 recognizes a position, type, speed, and the like of a physical object located near the vehicle M (within a predetermined distance) from a result of the sensor fusion process. The second recognizer 210 may have, for example, a function similar to that of the first recognizer 120. The second recognizer 210 may use the detection result of the camera 10 or the LIDAR unit 20 for the sensor fusion process. The second recognizer 210 may be omitted and the processing result of the first recognizer 120 described above may be used.

The second controller 220 executes control to assist the occupant (the driver) in driving on the basis of a recognition result of the second recognizer 210. The second controller 220 generates a target trajectory along which the vehicle M will travel in the future on the basis of the travel state of the vehicle M (a position and speed of the vehicle M) and the surrounding situation of the vehicle M (a road situation, positions of nearby physical objects, and the like). The second controller 220 may execute driving control of the vehicle M like the first controller 140.

The second vehicle controller 230, for example, acquires information about a target trajectory (trajectory points) generated by the second controller 220 and stores the acquired information in a memory (not shown). The second vehicle controller 230 controls the travel driving force output device 400 and the brake device 410 on the basis of a speed element associated with the target trajectory stored in the memory. The second vehicle controller 230 controls the steering device 420 according to the curvature of the target trajectory stored in the memory. The process of the second vehicle controller 230 is implemented, for example, by a combination of feedforward control and feedback control. As an example, the second vehicle controller 230 executes a combination of feedforward control according to the curvature of the road in front of the vehicle M and feedback control based on the deviation from the target trajectory. The second vehicle controller 230 may perform driving control of the vehicle M on the basis of the target trajectory generated by the first controller 140.

### Switching Controller 300

The switching controller 300 switches the control between control (first control) to be executed by the first control device 100 and control (second control) to be executed by the second control device 200 and controls the start and end of control. In the embodiment, the first control and the second control have different control aspects for the vehicle M. The control aspect is, for example, a method and behavior of the driving control, and the like. More specifically, the control aspect is a condition, processing performance, type, and the like for executing the control. For example, in the first control, a predetermined operation in the driving control based on the surrounding situation is executed without receiving an operation indicating an instruction or permission from the occupant (the driver) using the operator 46 (regardless of the presence or absence of an operation), and in the second control, it is decided whether or not to execute a predetermined operation in the driving control on the basis of the operation content from the occupant, and control according to the decision is executed.

In terms of the above-described processing performance, the processing performance of the first control device 100 is higher than that of the second control device 200. In this case, for example, the first control device 100 can also execute driving control in other road situations in addition to a road situation (a travel scene) in which the second control device 200 can execute the driving control.

In the above-described types, when the second control has, for example, a function of an advanced driver assistance system (ADAS), the first control may have a junction passing function, a merging function, and the like, in addition to the function of the ADAS. The ADAS includes, for example, predetermined operations in driving control such as adaptive cruise control (ACC), lane keeping assistance system (LKAS), forward collision warning (FCW), collision mitigation braking system (CMBS), and auto lane changing assist (ALCA). In the lane change (ALCA) in the second control, the lane change is made after an operation instruction (e.g., an instruction of the lane change destination) is received from the driver, whereas in the lane change (auto lane changing (ALC)) in the first control, the lane change is made on the basis of the surrounding situation without receiving an operation instruction from the driver (regardless of the presence or absence of an operation).

### Regarding Travel Scenes

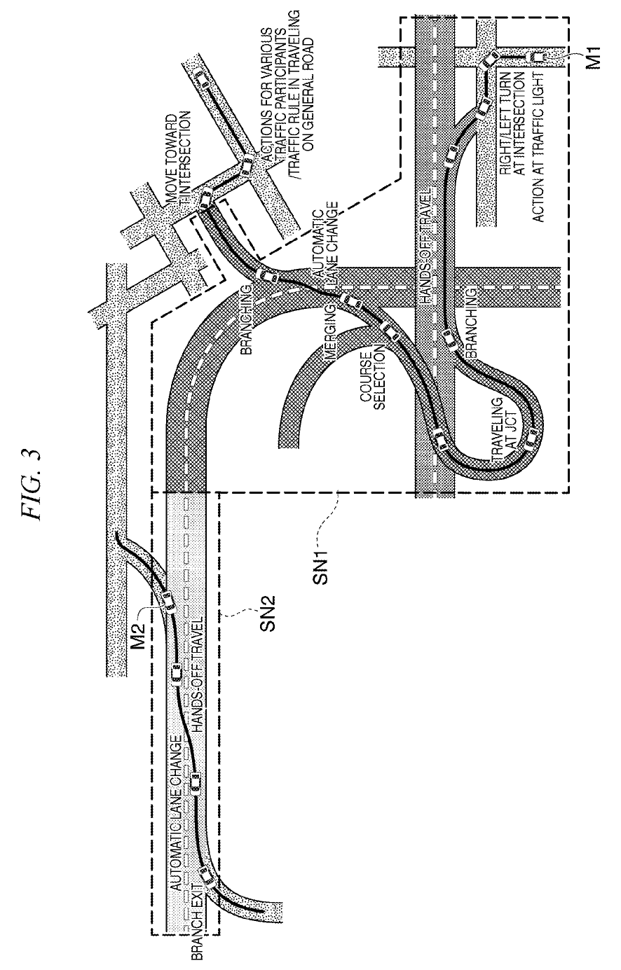

Here, the road situations (travel scenes) in which the first control and the second control described above are executed will be specifically described. FIG. 3 is an explanatory diagram of travel scenes in which the first control and the second control can be executed. In the example of FIG. 3, a first travel scene SN1 and a second travel scene SN2 are shown. In the example of FIG. 3, an example of driving control of a vehicle M1 traveling in the first travel scene SN1 and an example of driving control of a vehicle M2 traveling in the second travel scene SN2 are shown together with travel trajectories of the vehicles M1 and M2. Although the road in the first travel scene SN1 is a general road (e.g., a trunk road of a general road) in an urban area and the road in the second travel scene SN2 is an expressway in the example of FIG. 3, the road situations and the like are not limited thereto. For example, the first travel scene SN1 may include an expressway in a connection portion between the first travel scene SN1 and the second travel scene SN2 and the like. The roads other than the first travel scene SN1 and the second travel scene SN2 are, for example, narrow streets, but are not particularly limited thereto. The switching controller 300 classifies an area where the first control can be performed and an area where the second control can be performed on the basis of the road situation in which the vehicle M is traveling, as shown in FIG. 3.

The first travel scene SN1 is an area (a scene) in which the first control can be executed. According to the execution of the first control, it is possible to turn right or left at an intersection, stop or start at a traffic light, perform merging, travel at a junction (JCT), select a course, perform branching, move toward a T-intersection, take actions for various traffic participants on general roads, and perform a travel process according to traffic rules based on road signs. In the first control, advanced technology and convenience can be provided according to driving control (driving assistance) corresponding to various scenes that the vehicle M1 encounters when traveling to a destination. In the first control, driving control can be performed even if the destination is not clearly determined. When the destination is not determined, for example, optimal and rational driving control is executed with respect to the scene to be encountered on the basis of the surrounding situation. In the first control, continuous function evolution can be performed by sequentially updating software for executing the first control installed in the vehicle M according to a communication means such as over the air (OTA) and the like, and it is possible to provide added value that enables the occupants to experience evolutionary changes in the vehicle M.

The second travel scene SN2 is an area (a scene) in which the second control can be executed. According to the execution of the second control, the vehicle M2 is controlled to perform a hands-off travel process (a travel process in a state in which the driver is not touching (holding) the steering wheel 72) during traveling on an expressway, an automatic lane change (ALCA) to an adjacent lane, a lane change to a branch exit lane, or the like. In the second control, the junction passing function and merging function that can be executed in the first control cannot be executed and the sensor (e.g., a LIDAR sensor) and algorithm used by the first control device 100 cannot be used.

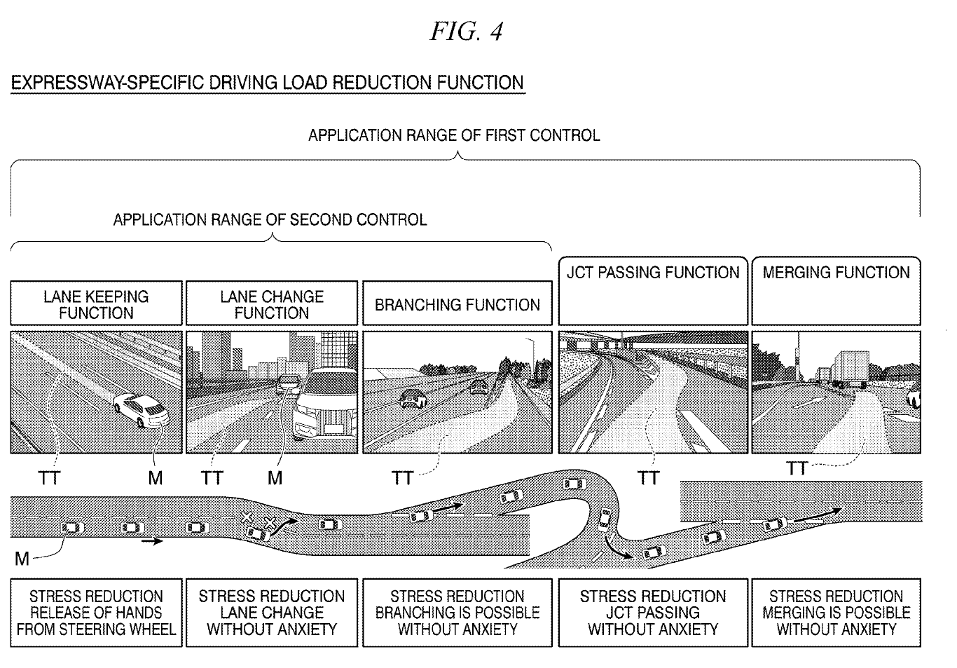

FIG. 4 is an explanatory diagram of specific examples of application ranges of the first control and the second control. In the example of FIG. 4, the application range of each of the first control and the second control for an “expressway-specific driving load reduction function” is shown. In the example of FIG. 4, in the first control, a lane keeping function (LKAS), a lane change function (ALC), a branching function (a lane change to a branch exit lane), a junction (JCT) passing function, a merging function, and the like can be executed during traveling on an expressway, and stress is reduced by reducing the load on the driver during traveling. In this control, the first control device 100 generates a target trajectory TT along which the vehicle M will travel in the future, and executes driving control so that the vehicle M travels along the generated target trajectory TT. Thus, when each of the above-described functions is executed, for example, the occupant can release his/her hands from the steering wheel 72 (a handle) in the lane keeping function among the functions and lane changing, branching, passing through a JCT, and merging to be executed without anxiety can be executed in the other functions. In the example of FIG. 4, in the second control, the lane keeping function, the lane change function, and the branching function can be executed, but the junction passing function and the merging function are not executed. Furthermore, for each function in the second control, for example, the occupant is notified of inquiry information about whether or not to execute the function or the like and the occupant then decides whether or not to execute the function according to an operation on the operator 46 or the like.

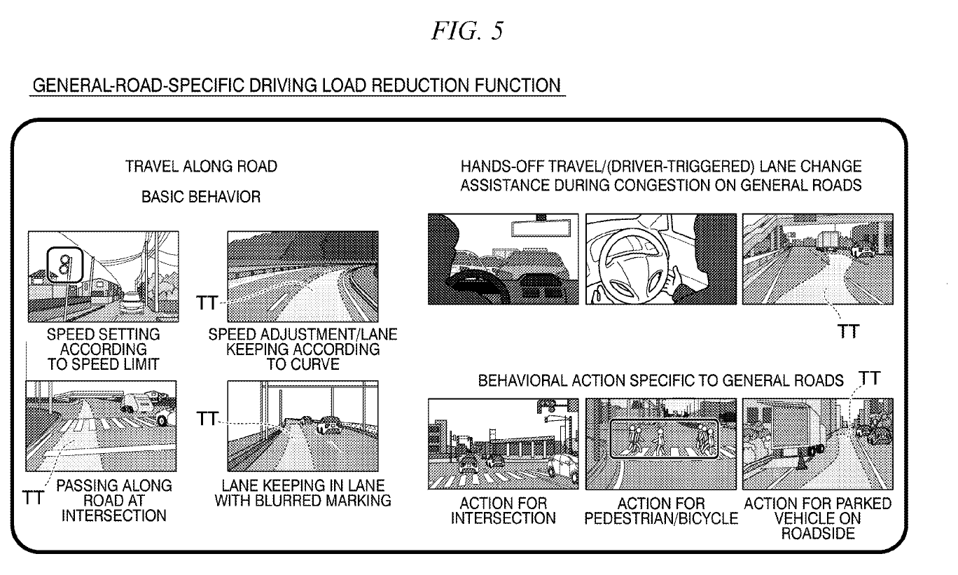

FIG. 5 is an explanatory diagram of specific examples of a further application range of the first control. In the first control, in addition to the above-described “expressway-specific driving load reduction function,” a “general-road-specific driving load reduction function” is also provided. In the first control, as shown in FIG. 5, as basic behaviors of a travel process based on traveling along a road, speed setting according to a speed limit of a road sign, speed adjustment and lane keeping according to a curve (curvature), passing along a road at an intersection, lane keeping control in a lane with a blurred marking, and the like are performed. In the first control, control processes related to hands-off travel and lane change assistance (e.g., a driver-triggered lane change) during congestion on general roads, and behavioral actions specific to general roads (e.g., an action for an intersection, an action for a pedestrian or a bicycle, or an action for a parked vehicle on the roadside) is performed. These control processes are implemented, for example, by acquiring more detailed surrounding recognition results including a recognition result of the first recognizer 120 of the first control device 100 (a recognition result of the LIDAR unit 20). The first control device 100 generates a target trajectory TT as necessary and causes the vehicle M to travel along the generated target trajectory TT.

In the first control, control in the second travel scene SN2 as shown in FIG. 3 is also possible. In this case, in the first control, control processes such as hands-off travel, an automatic lane change (ALC in the first control), a lane change to a branch exit lane, and the like are executed. In the first control, when a destination is not input to the navigation device 80, traveling along the road is executed in all travel processes other than junction (JCT) passing when exiting and passing through a junction (JCT) on an expressway. Thereby, this can be executed as a driving assistance function such as ACC or LKAS for supporting traveling along the road without linking with a navigation system. Thus, in the first control, driving control with a reduced operation intervention frequency can be executed even for travel situations in which the trouble of inputting a destination is eliminated as assumed in daily traveling. In the second control, only predetermined driving control (e.g., ACC or LKAS) may be executed in the first travel scene SN1 on a general road or the like.

Here, when the vehicle M is traveling in the first travel scene SN1 or the second travel scene SN2 or is predicted to travel in the first travel scene SN1 or the second travel scene SN2 in the near future, on the basis of the position of the vehicle M and a nearby travel scene, the switching controller 300 notifies the occupant (the driver or the like) of inquiry information or the like via the HMI 40, and controls the start (or end) of the first control or the second control, or the switching between the first control and the second control, according to an instruction input from a predetermined operation element provided in the operator 46. In addition to switching between the above-described control aspects, the switching controller 300 performs a control process so that the settings of various types of parameters, such as speed adjustment, vehicle speed setting, and adjustment of an inter-vehicle distance from a preceding vehicle, selected by the driver in each control aspect are received from the same operation element.

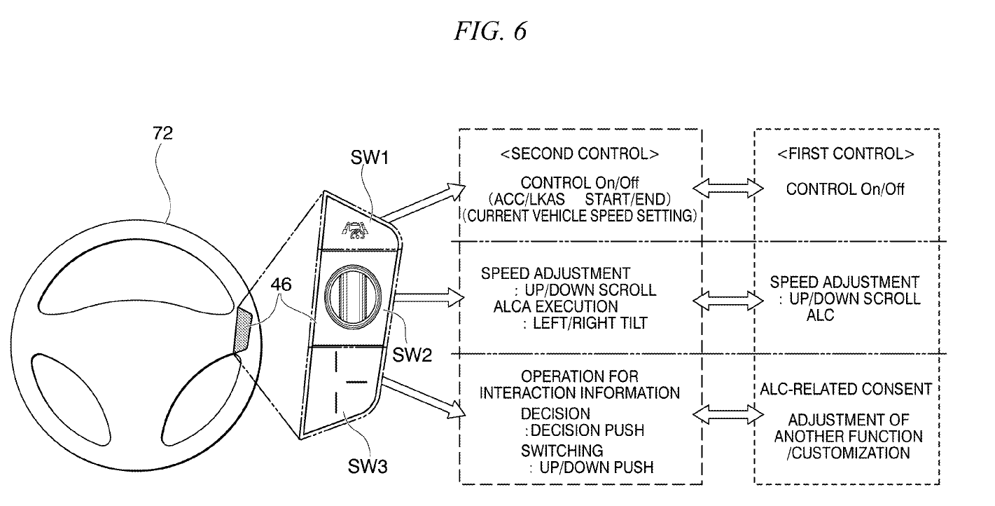

FIG. 6 is a diagram showing an example of the operator 46. In the example of FIG. 6, the operator 46 is provided on the right side of the steering wheel 72. In the example of FIG. 6, three switches (a first switch SW1, a second switch SW2, and a third switch SW3) are vertically arranged in the operator 46. It is only necessary for the operator 46 in the embodiment to have a plurality of operation elements, and the number of switches SW, an arrangement of the switches SW, and types of the switches SW are not limited to the example of FIG. 6. The switch is an example of an “operation element,” and a button, a lever, a touch pad, a track button, and the like may be used instead of the switch.

In the example of FIG. 6, the first switch (first operation element) SW1 is a button switch and the second switch (second operation element) SW2 is a wheel switch having a wheel part that can rotate up and down in the center. The wheel part can be tilted to the left/right. The third switch (third operation element) SW3 has a sensor that detects finger movement in the up-down direction, and further has a sensor that detects a decision instruction according to the touch with a finger on the right side thereof. The switching controller 300 receives different operation content for each control aspect (e.g., the first control or the second control) to be executed, even if the switch operation is the same for each control process.

Here, in the travel scene (the road situation) as shown in FIG. 3, it is assumed that the first travel scene SN1 satisfies the execution condition of the first control and the second travel scene SN2 satisfies the execution condition of the second control. The switching controller 300 determines whether or not the vehicle M is located in the first travel scene SN1 or in the second travel scene SN2 on the basis of the position of the vehicle M and map information (the first map information 84 and the second map information 92) obtained from the vehicle sensor 50 and the like or determines whether the vehicle M will be located in the first travel scene SN1 or the second travel scene SN2 in the near future (within a predetermined time) on the basis of the position, speed, travel direction, and the like of the vehicle M. The switching controller 300 may determine whether the vehicle M is located in the first travel scene SN1 or the second travel scene SN2 or whether the vehicle M will be located in the first travel scene SN1 or the second travel scene SN2 in the near future on the basis of the nearby road situation, the road signs, or the like on the basis of the recognition result of the first recognizer 120 or the second recognizer 210. The switching controller 300 may perform the above-described determination by combining the map information and the recognition result.

For example, when it is determined that the vehicle M is located in the first travel scene SN1 (or the vehicle M will be located in the first travel scene SN1 in the near future), the switching controller 300 generates information (e.g., images and sounds) indicating current and future vehicle states and notifies the occupant (the driver) of the generated information by outputting the generated information to the HMI 40. The information indicating the vehicle state includes, for example, information indicating that the vehicle M is capable of executing the first control (or the vehicle M will be capable of executing the first control in the near future), and inquiry information regarding whether or not to execute the first control. Furthermore, the information indicating the vehicle state may include information about the driving control (operation) that can be executed in the first control, the merit of executing the first control, and an explanation of content to be received when the first to third switches SW1 to SW3 are operated during execution of the second control.

Likewise, when it is determined that the vehicle M is located in the second travel scene SN2 (or the vehicle M will be located in the second travel scene SN2 in the near future), the switching controller 300 generates information indicating the current and future vehicle states, and notifies the occupant (the driver) of the generated information by outputting the generated information to the HMI 40. In this case, the information indicating the vehicle state includes, for example, information indicating that the vehicle M is capable of executing the second control (or the vehicle M will be capable of executing the second control in the near future), and inquiry information about whether or not to execute the second control. Furthermore, the information indicating the vehicle state may include information about the driving control (the operation) that can be executed in the second control, the merit of executing the second control, and an explanation of content to be received when the first to third switches SW1 to SW3 are operated during execution of the second control.

When the first switch SW1 is operated (when the ON operation is performed) after the inquiry information about whether or not to execute the first control is notified, the switching controller 300 executes the first control at a timing when the first control becomes executable (e.g., at a timing when the vehicle M enters the area of the first travel scene SN1). When the second control is being executed, the switching controller 300 switches the control from the second control to the first control. When the first switch SW1 is operated after the inquiry information on whether or not to execute the second control is notified, the switching controller 300 executes the second control at a timing when the second control becomes executable (e.g., at a timing when the vehicle M enters the area of the second travel scene SN2). When the first control is being executed, the switching controller 300 switches the control from the first control to the second control.

When the first switch SW1 is operated while the first control or the second control is being executed, the switching controller 300 ends the control that is currently being executed. When a preset execution condition for ACC, LKAS, or the like is satisfied while the second control is being executed, the switching controller 300 generates information indicating that ACC or LKAS is executable and inquiry information about whether or not to execute the ACC or LKAS, and outputs the information to the HMI 40. When the first switch SW1 is operated subsequently, the switching controller 300 executes the ACC or LKAS. When the first switch SW1 is operated while ACC- or LKAS-based driving control is being executed, the switching controller 300 ends the driving control that is currently being executed.

When the wheel part of the second switch SW2 is scrolled up or down during execution of the first control, the switching controller 300 receives an adjustment of the set speed of the vehicle M when a predetermined operation (e.g., ACC) of the first control is executed, or an adjustment of the inter-vehicle distance from the preceding vehicle. The switching controller 300 receives an operation (a lane change instruction) of whether or not to make a lane change (e.g., ALC) when a predetermined condition (e.g., a predetermined automation level) is satisfied by operating the wheel part during the execution of the first control.

During the execution of the first control, the switching controller 300 receives instructions regarding the ALC (e.g., an instruction to consent to inquiry information about the ALC), adjustments of parameters of other functions, and customization of other setting information by the driver through the third switch SW3. During the execution of the second control, the switching controller 300 receives operations for the information (interaction information) displayed on the display 42 via the third switch SW3. As an operation of the third switch SW3, for example, display content such as scrolling and increasing or decreasing the numerical values displayed on the display 42 is switched by pressing the up/down switch and instructions about the information selected on the screen are received by pressing a decision switch.

Thus, in the embodiment, the same operation element can be used to receive different instructions according to the driving assistance mode being executed. Thereby, it is possible to reduce costs associated with an increase in the number of operation elements and further reduce the user’s workload because it is only necessary for the user to ascertain the positions and functions of a small number of operation elements.

For example, when the switching of the control aspect is possible on the basis of the surrounding situation (when the execution condition is satisfied) and an instruction from the operator 46 is received, the switching controller 300 executes switching from the first control to the second control or executes switching from the second control to the first control. The switching controller 300 notifies the driver of inquiry information about whether or not to execute the first control or the second control by outputting the inquiry information from the display 42 or the speaker 44, and then determines whether or not to switch on the basis of information indicated from the first switch SW1. For example, when a switching instruction is received, the switching controller 300 executes switching from the first control to the second control or switching from the second control to the first control, and does not execute switching to the first control or the second control when an instruction from the first switch SW1 is not received. Thus, when the control of the vehicle M is switched, the occupant ascertains whether or not it is necessary and performs an instruction operation therefor, such that the user can correctly understand the change in control. The switching controller 300 also provides a notification of similar inquiry information when the first control or the second control is executed from a state in which no driving control is being executed (a fully manual driving state), and decides whether or not to execute control on the basis of the subsequent operation content.

The switching controller 300 may be configured not to switch the control to the first control when a notification of inquiry information about whether to switch the control to the first control is provided during the execution of the second control, and when the state in which the operator 46 is not operated after the notification continues for a predetermined time or more. In this case, even if the vehicle M enters the first travel scene SN1, a control process is executed to continue the second control for as long as possible. Moreover, in contrast, during the execution of the first control, a notification of inquiry information about whether or not to switch the control to the second control is provided, and switching to the second control may not be executed when the state in which the operator 46 is not operated after the notification continues for a predetermined time or more. In this case, even if the vehicle M enters the second travel scene SN2, a control process is executed to continue the first control for as long as possible.

The switching controller 300 may decide whether or not to execute a predetermined operation on the basis of the content received by the operator 46 when the second control is being executed and may execute the predetermined operation regardless of the presence or absence of an operation on the operator 46 (regardless of the content received by the operator 46) when the first control is being executed. The predetermined operation is, for example, a lane change of the vehicle M, but is not limited thereto and may be other driving control (e.g., ACC or LKAS) or the like.

The switching controller 300 may execute third control different from the first control and the second control when the operating state of the vehicle M satisfies a predetermined condition while the first control or the second control is being executed. The predetermined condition here is, for example, a case where the surroundings of the vehicle M (particularly a forward area) are congested and the host vehicle is traveling (or stopped) at a low speed equal to or lower than a predetermined speed. In this case, the third control becomes, for example, TJP control in which a travel process is performed by maintaining an inter-vehicle distance while adapting to changes in the vehicle speed of the preceding vehicle during traveling at a low speed such as in a traffic jam. The predetermined condition and the third control are not limited to this.

An instruction from the driver as to whether or not to switch the control to the third control (a switching instruction) may be received according to an operation of an operation element (e.g., the second switch SW2, the third switch SW3, or another operation element) different from an operation (e.g., the operation of the first switch SW1) different from the switching from the first control to the second control and the switching from the second control to the first control. Thereby, for the control under a specific condition (the third control), the content of the instruction operation is made different, so that the driver can more accurately understand the separation between the first control and the second control.

The switching controller 300 switches the control to a control aspect different from the first control or the second control when the execution condition of the third control is no longer satisfied during execution of the third control described above (e.g., when the traffic jam is eliminated). The different control aspect may be, for example, an aspect in which the driving control ends and the driving mode is switched to the manual driving, or control in which the driving mode (automation level) is lowered. Thereby, it is possible to issue an instruction to execute the first control or the second control again when the condition of the third control is no longer satisfied, and allows the occupant to more clearly understand the transition of control.

In the embodiment, in the first control, the first control device 100 generates a target trajectory of the vehicle M. In the second control, the second control device 200 generates a target trajectory of the vehicle M. In the embodiment, on the basis of the target trajectory generated by the first control device 100 or the second control device 200, one control device (e.g., the second control device 200) controls the travel driving force output device 400, the brake device 410, and the steering device 420 so that driving control for controlling at least one of the steering and speed of the vehicle M is executed. Thereby, it is possible to unify the process related to the driving control, thereby making it possible to further stabilize the behavior of the vehicle M.

### Flowchart

Next, a flow of a process executed by the vehicle system 1 will be described. In the following processing, a process of switching the control aspect in accordance with the operation situation of the operator 46 among processes executed by the vehicle system 1 will be mainly described. It is assumed that the first control aspect of the first control device 100 or the second control aspect of the second control device 200 is already being executed at the start of the process.

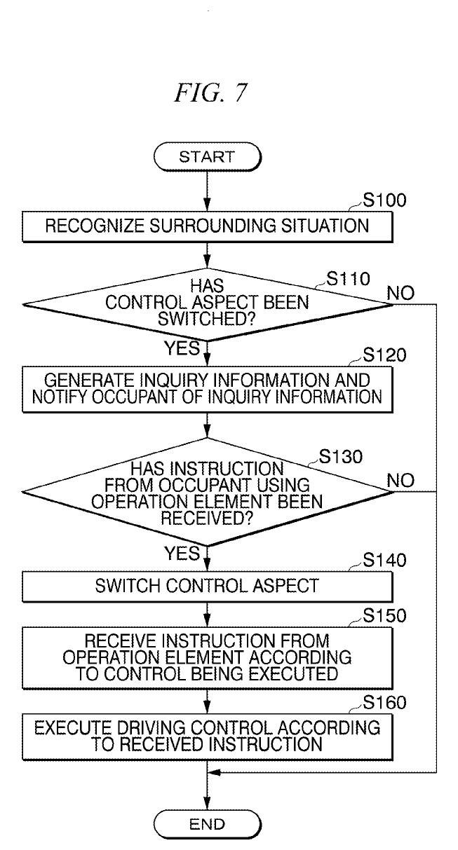

FIG. 7 is a flowchart showing an example of a flow of a process executed by the vehicle system 1 of the embodiment. In the example of FIG. 7, the switching controller 300 recognizes a surrounding situation of the vehicle M on the basis of a recognition result of the recognizer (the first recognizer 120 or the second recognizer 210) provided in a control device (the first control device 100 or the second control device 200) corresponding to the control being executed (step S100). In the processing of step S100, the surrounding situation may be recognized on the basis of recognition results of both the first recognizer 120 and the second recognizer 210 during the execution of the first control. Subsequently, the switching controller 300 determines whether or not to switch the control aspect being executed on the basis of the surrounding situation of the vehicle M (step S110). When it is determined that the driving assistance mode is to be switched, the switching controller 300 generates inquiry information and notifies the occupant of the generated inquiry information (step S120).

Subsequently, the switching controller 300 determines whether or not an instruction has been received from the occupant using a predetermined operation element included in the operator 46 with respect to the inquiry information (step S130). When it is determined that the instruction has been received, the switching controller 300 switches the control aspect (step S140). Subsequently, the control device (the first control device 100 or the second control device 200) that has become an execution target according to the switching receives an instruction from a predetermined operation element from the operator according to the control being executed (step S150), and executes the driving control according to the received instruction (step S160). Thereby, the process of this flowchart ends. When it is determined that the control aspect is not to be switched in the processing of step S110 or when it is determined that an instruction from the occupant using the operation element has not been received in the processing of step S130, the process ends as it is without switching the control.

### Modified Example

In the above-described embodiment, a part of the first travel scene SN1 shown in FIG. 3 may include an area (a segment) in which the second control is executable, and a part of the second travel scene SN2 may include an area (a segment) in which the first control is executable. In this case, an inquiry corresponding to the switching segment or switching control according to an operation of the operator may be performed. In the embodiment, information about the segment in which the first control is executable and the segment in which the second control is executable may be included in the map information, and control related to the above-described control aspect switching process may be performed in accordance with the segment acquired from the map information. The function of the switching controller 300 in the embodiment may be provided in one of the first control device 100 and the second control device 200.

According to the embodiment described above, there is provided a vehicle control device including: a recognizer (the first recognizer 120 and the second recognizer 210) configured to recognize a surrounding situation of a vehicle (M); a driving controller (the first controller 140, the first vehicle controller 160, the second controller 220, the second vehicle controller 230, and the switching controller 300) configured to execute driving control for controlling at least one of steering and a speed of the vehicle (M) on the basis of the surrounding situation; and an operator (46) configured to receive an operation from an occupant of the vehicle (M), wherein the driving controller executes the driving control on the basis of any one of a plurality of control aspects including first control and second control having content of driving assistance different from that of the first control, wherein the driving controller executes switching from the first control to the second control or switching from the second control to the first control when an instruction is received from the operator (46) if the control aspect is switchable on the basis of the surrounding situation, and wherein the driving controller prevents the switching from being executed when the instruction is not received from the operator (46), whereby it is possible to execute more appropriate driving control in accordance with the surrounding situation of the vehicle. Specifically, according to the embodiment, when the control aspect transitions, the occupant can correctly understand the change in the control aspect when the occupant is allowed to perform an operation.

The embodiment described above can be represented as follows. A vehicle control device including: a storage medium storing computer-readable instructions; and a processor connected to the storage medium, the processor executing the computer-readable instructions to: recognize a surrounding situation of a vehicle; execute driving control for controlling at least one of steering and a speed of the vehicle on the basis of the surrounding situation; execute the driving control on the basis of any one of a plurality of control aspects including first control and second control having content of driving assistance different from that of the first control; execute switching from the first control to the second control or switching from the second control to the first control when an instruction is received from an operator configured to receive an operation from an occupant of the vehicle if the control aspect is switchable on the basis of the surrounding situation; and prevent the switching from being executed when the instruction is not received from the operator.

Although modes for carrying out the present invention have been described above using embodiments, the present invention is not limited to the embodiments and various modifications and substitutions can also be made without departing from the scope and spirit of the present invention.

What is claimed is:

1. A vehicle control device comprising:
a recognizer configured to recognize a surrounding situation of a vehicle;
a driving controller configured to execute driving control for controlling at least one of steering and a speed of the vehicle on the basis of the surrounding situation; and
an operator configured to receive an operation from an occupant of the vehicle,
wherein the driving controller executes the driving control on the basis of any one of a plurality of control aspects including first control and second control having content of driving assistance different from that of the first control,
wherein the driving controller executes switching from the first control to the second control or switching from the second control to the first control when an instruction is received from the operator if the control aspect is switchable on the basis of the surrounding situation, and
wherein the driving controller prevents the switching from being executed when the instruction is not received from the operator.

2. The vehicle control device according to claim 1, wherein the driving controller decides whether or not to execute a predetermined
operation on the basis of content received by the operator during execution of the second control, andwherein the driving controller executes the predetermined operation regardless of the presence or absence of an operation of the operator during execution of the first control.

3. The vehicle control device according to claim 2, wherein the predetermined operation includes a lane change of the vehicle.

4. The vehicle control device according to claim 1, wherein the driving controller switches the control to third control different from the first control and the second control when a state of the vehicle satisfies a predetermined condition during execution of the first control or the second control, andwherein an instruction to switch the control to the third control is issued according to an operation different from an operation for switching from the first control to the second control and an operation for switching from the second control to the first control.

5. The vehicle control device according to claim 4, wherein the driving controller switches the control to control different from the first control or the second control when an execution condition for the third control is not satisfied during execution of the third control.

6. The vehicle control device according to claim 1, wherein the driving controller includes a first control device configured to execute the first control; anda second control device configured to execute the second control, andwherein the driving controller generates a target trajectory of the vehicle with the first control device in the first control, andgenerates a target trajectory of the vehicle with the second control device in the second control.

7. The vehicle control device according to claim 1, wherein the operator includes a plurality of operation elements including a first
operation element, a second operation element, and a third operation element,
wherein the first operation element receives an instruction to execute the first control or the second control or an instruction to switch the control to the first control or the second control and an instruction to start or end execution of a predetermined operation when the second control is executed,
wherein the second operation element receives a setting speed of the vehicle in the predetermined operation and receives a lane change instruction, and
wherein the third operation element performs an operation for information displayed on a display when the second control is executed and receives an instruction regarding a lane change when the first control is executed.

8. The vehicle control device according to claim 7, further comprising a notifier configured to provide notifications of current and future vehicle states when an execution condition for the control aspect is satisfied.

9. The vehicle control device according to claim 8, wherein the driving controller prevents the control from being switched to the first control when a state in which the operator is not operated continues for a predetermined time or more after an inquiry regarding the switching to the first control is provided to the notifier during execution of the second control.

10. The vehicle control device according to claim 1, wherein the driving controller classifies an area where the first control is executable and an area where the second control is executable on the basis of a road situation of the vehicle.

11. A vehicle control method comprising:
recognizing, by a computer, a surrounding situation of a vehicle;
executing, by the computer, driving control for controlling at least one of steering and a speed of the vehicle on the basis of the surrounding situation;
executing, by the computer, the driving control on the basis of any one of a plurality of control aspects including first control and second control having content of driving assistance different from that of the first control;
executing, by the computer, switching from the first control to the second control or switching from the second control to the first control when an instruction is received from an operator configured to receive an operation from an occupant of the vehicle if the control aspect is switchable on the basis of the surrounding situation; and
preventing, by the computer, the switching from being executed when the instruction is not received from the operator.

12. A computer-readable non-transitory storage medium storing a program for causing a computer to:
recognize a surrounding situation of a vehicle;
execute driving control for controlling at least one of steering and a speed of the vehicle on the basis of the surrounding situation;
execute the driving control on the basis of any one of a plurality of control aspects including first control and second control having content of driving assistance different from that of the first control;
execute switching from the first control to the second control or switching from the second control to the first control when an instruction is received from an operator configured to receive an operation from an occupant of the vehicle if the control aspect is switchable on the basis of the surrounding situation; and
prevent the switching from being executed when the instruction is not received from the operator.
